(19) United States
(12) Patent Application Publication
(10) Pub. No.: US 2012/0170590 A1
(43) Pub. Date: Jul. 5, 2012

(54) Bandwidth Arrangement Method and Transmitter Thereof

(75) Inventors: Shen-Ming Chung, Minxiong Township (TW); Chi-Chun Chen, Hsinchu City (TW); Lung-Chih Kuo, Xinying City (TW); Chang-Hsien Chen, Yilan City (TW)

(73) Assignee: INDUSTRIAL TECHNOLOGY RESEARCH INSTITUTE, Hsinchu (TW)

(21) Appl. No.: 13/073,874

(22) Filed: Mar. 28, 2011

(30) Foreign Application Priority Data
Dec. 29, 2010 (TW) 99146679

(51) Int. Cl. H04L 12/56

(52) U.S. Cl. 370/412

(57) ABSTRACT

A bandwidth arranging method includes the following steps of: registering isochronous packets of N isochronous streams, N is a natural number greater than 1; segmenting an isochronous transmission period into M sub-periods, M is a natural number greater than 1; arranging operation of transmitting each of the N isochronous streams in one of the M sub-periods and allocating corresponding bandwidth according to bandwidth requirement information corresponding to each of the N isochronous streams; arranging the isochronous packets into M output queues corresponding to the respective M sub-periods; outputting isochronous packets stored in the M output queues in the respective M sub-periods.

This application claims the benefit of Taiwan application Serial No. 99146679, filed Dec. 29, 2010, the subject matter of which is incorporated herein by reference.

### BACKGROUND

1. Technical Field

The disclosure relates in general to a bandwidth arrangement method and a transmitter thereof, and more particularly to a bandwidth arrangement method and a transmitter thereof capable of providing adequate transmission bandwidth for a number of isochronous streams.

2. Description of the Related Art

Along with Internet getting more and more general and development of digitized home appliances, network transmission scheme for isochronous stream has been developed to handle real time transmissions of transmission time sensitive packets, e.g. multimedia data packets. In general, present transmission schemes for isochronous streams follow IEEE 802.1 AV Bridging Task Group (IEEE 802.1 AVB) isochronous transmission standard to have the first 75% part of a cyclic transmission period designated as a transmission interval for isochronous packets and the last 25% part of the cyclic transmission period designated as a transmission interval for legacy packets. Thus, 75% of network bandwidth can be spared for isochronous packets under IEEE 802.1 AVB standard.

In an exemplary Ethernet environment with 1 gigabit per second (Gbps) transmission rate, isochronous packet transmission interval corresponds to 750 megabit per second (Mbps) transmission bandwidth, in other words, capable of allowing simultaneous transmissions for tens of high definition video streams. Thus, how to find a bandwidth arrangement method capable of arranging bandwidths of a number of video streams has become a prominent goal for the industries.

### SUMMARY

The disclosure is directed to a bandwidth arrangement method and a transmitter thereof. In comparison to conventional isochronous stream transmission device, the bandwidth arrangement method and the transmitter thereof is advantageously capable of arranging transmission bandwidths to a number of corresponding isochronous streams and assuring that each of the isochronous streams is allocated with adequate bandwidths for transmission.

According to a first aspect of the present disclosure, a transmitter provided in a network environment is provided, wherein the transmitter comprises an input port, a bandwidth reservation unit, and a first output port. The input port comprises an input queue for temporally storing a plurality of first isochronous packets corresponding to N first isochronous streams, each of which comprises first stream identification information and first bandwidth requirement information, wherein N is a natural number greater than 1. The bandwidth reservation unit has an isochronous transmission period segmented into M sub-periods, each of which corresponds with a first transmission bandwidth. The bandwidth reservation unit further establishes a first stream lookup table and has transmission operations of each of the N first isochronous streams arranged in one of the M sub-periods according to first bandwidth requirement information corresponding to the respective N first isochronous streams, so as to have each of the N first isochronous streams arranged with a corresponding data transmission bandwidth, wherein M is a natural number greater than 1 and is relevant to a transmission bandwidth and a packet length of the network environment. The first output port comprises M first isochronous output queues, a first packet assign unit, and a first output unit. The first isochronous output queues correspond to the respective M sub-periods. The first packet assign unit receives and allocates the first isochronous packets to the M first isochronous output queues according to the first stream lookup table. The first output unit transmits the first isochronous packets stored in the M first isochronous output queues in the respective M sub-periods within the isochronous transmission period.

According to a second aspect of the present disclosure, a bandwidth arrangement method applied in a transmitter is provided. The bandwidth arrangement method comprises the following steps of: receiving and temporally storing a plurality of isochronous packets corresponding to N isochronous streams in an input queue, each of the N isochronous streams comprising stream identification information and bandwidth requirement information, wherein N is a natural number greater than 1; having an isochronous transmission period segmented into M sub-periods, each of which corresponds with a transmission bandwidth, wherein M is a natural number greater than 1 and is relevant to a transmission bandwidth and a packet length of the network environment; having transmission operations of each of the N isochronous streams arranged in one of the M sub-periods according to bandwidth requirement information corresponding to the respective N isochronous streams, so as to have each of the N isochronous streams arranged with a corresponding data transmission bandwidth, and establishing a stream lookup table; allocating the isochronous packets to M isochronous output queues corresponding to the respective M sub-periods according to the stream lookup table; and transmitting the isochronous packets stored in the M isochronous output queues in the respective M sub-periods within the isochronous transmission period.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 is a block diagram of the transmitter according to an embodiment.

FIG. 2 is a frame illustration of a cyclic transmission period.

FIG. 3 is a detailed block diagram of the bandwidth reservation unit 14 of FIG. 1.

FIG. 4 is a detailed block diagram of a stream assign unit 14c shown in FIG. 3.

FIG. 5 is a detailed block diagram of a bandwidth management unit 14b shown in FIG. 3.

FIG. 6 is a detailed block diagram of the packet assign unit 16a shown in FIG. 1.

FIG. 7 is another block diagram of the transmitter according to the embodiment.

FIG. 8 is a flow chart of a bandwidth arrangement method according to the embodiment.

FIG. 9 is an illustration of a registration information packet according to the embodiment.

FIG. 10 is an illustration of a format of a stream lookup table SLT according to the embodiment.

### DETAILED DESCRIPTION

The bandwidth arrangement method and the transmitter thereof directed by the disclosure arranges a number of sub-periods in an isochronous transmission period according to a network environment parameter and carries out isochronous transmission operation in each of the sub-periods.

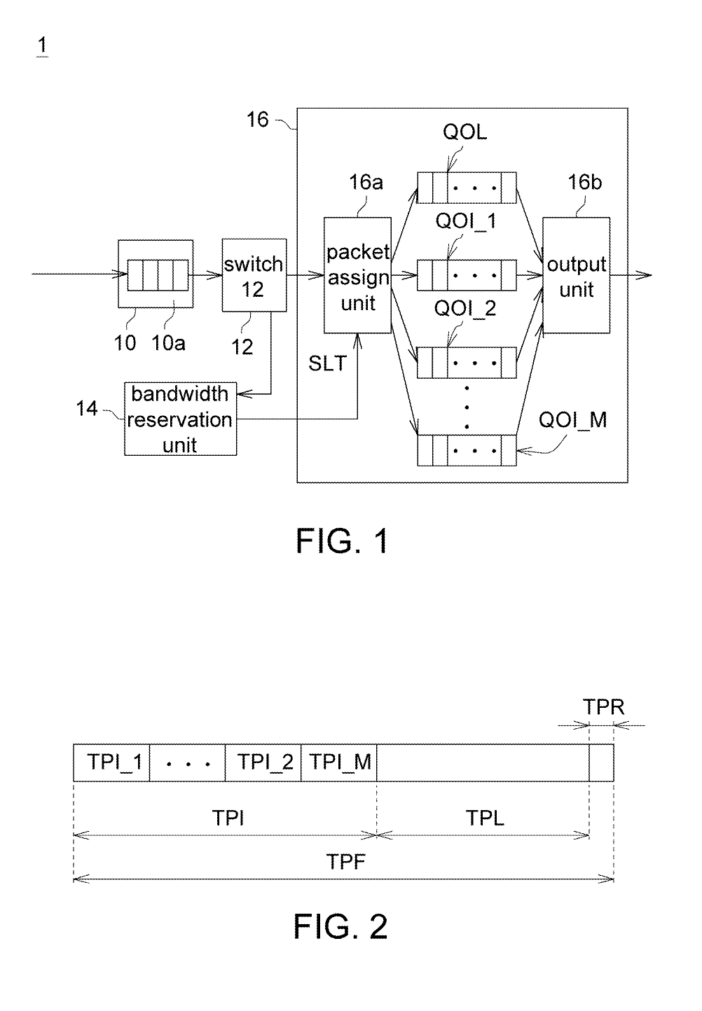

Referring to FIG. 1, a block diagram of the transmitter according to an embodiment is shown. The transmitter 1 is applied in a network environment for handling transmission operations between an input end and an output end. The transmitter 1 includes an input port 10, a switch 12, a bandwidth reservation unit 14, an output port 16, and so forth. The input port 10 includes an input queue 10a for storing input packets, including isochronous packets and asynchronous packets for example.

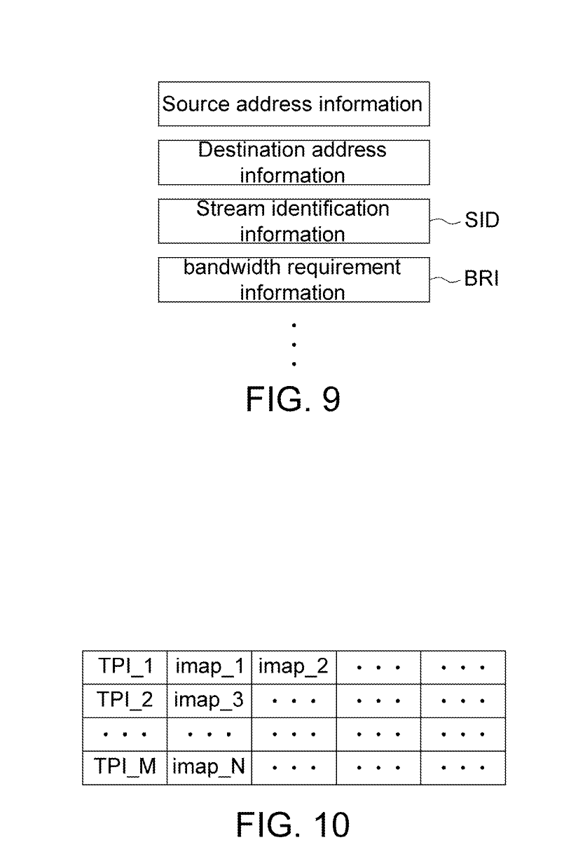

The switch 12 receives packets stored in the input queue 10a and output the asynchronous packets and the isochronous packets, which correspond to n isochronous streams Ss_1, Ss_2, . . . , Ss_n, wherein n is a natural number greater than 1. Each of the asynchronous packets includes a registration information packet, which is provided to a bandwidth reservation unit 14 by the switch 12. In an example, the registration information packet includes stream identification information SID, bandwidth requirement information BRI, source information of the asynchronous packet, destination information of the asynchronous packet, as depicted in FIG. 9. In other example, the registration information packet can also be directly provided from the input port 10 to the bandwidth reservation unit 14, rather than provided via the switch 12.

In an operational example, corresponding to each of the isochronous streams, the switch 12 finds isochronous packets corresponding to the output port 16 from the isochronous packets stored in the input queue 10a based on the destination information of each of the isochronous streams, so that the output port 16 can accordingly carry out transmission operation of the n isochronous streams Ss_1-Ss_n.

The bandwidth reservation unit 14 has an isochronous transmission period TPI segmented into M sub-periods TPI_1, TPI_2, . . . , TPI_M, each of which corresponds with a transmission bandwidth BW, wherein M is relevant to the transmission bandwidth and the packet length of the network environment. For example, the transmitter 1 follows IEEE 802.1 AV Bridging Task Group (IEEE 802.1 AVB) isochronous transmission standard. Thus, a cyclic transmission period TPF of the transmitter 1 is set as 125 microseconds (μs), in which the M sub-periods TPI_1-TPI_M corresponding to isochronous transmission correspond to about 75% of the transmission period TPF in length, i.e. 93.75 μs, and a asynchronous transmission period TPL corresponding to asynchronous transmission corresponds to about 25% of the transmission period TPF in length, i.e. 31.25 μs, as depicted in FIG. 2.

The transmission bandwidth BW of each of the M sub-periods TPI_1-TPI_M is determined by network environment parameters. For example, the network environment corresponds to a transmission rate of 1 Gigabyte per second (Gbps), so that the transmission bandwidth BW of each of the M sub-periods TPI_1-TPI_M is roughly 93.75/M Gbps.

Value of M is relevant to the transmission bandwidth and the packet length of the network environment. For example, M satisfies:

$$M = ⌊ \frac{BW\_TPI}{P max} ⌋$$

Wherein BW_TPI is the transmission bandwidth of the isochronous transmission period TPI, Pmax is the maximum packet length in the network environment, and M is the greatest integer smaller than or equal to the quotient of the transmission bandwidth BW_TPI and the maximum packet length Pmax. In an example with the transmission bandwidth BW_TPI equal to 1 Gbps and the maximum length Pmax equal to 1.5 kilobyte (Kb), M satisfies:

$$M = ⌊ \frac{BW\_TPI}{P max} ⌋ = ⌊ \frac{1 Gbps \times 75 \% \times 125 μs}{1.5 KB} ⌋ = 7$$

The bandwidth reservation unit 14 manages registration operation of the isochronous streams. For example, when the registration information packet is received, the bandwidth reservation unit 14 have the transmission operation of each of the n isochronous streams Ss_1-Ss_n arranged in one of the M sub-periods TPI_1-TPI_M according to the bandwidth requirement information BRI _1-BRI_n corresponding to the respective n isochronous streams Ss_1-Ss_n, so as to achieve bandwidth registration operation for having each of the n isochronous streams Ss_1-Ss_n arranged with a corresponding data transmission bandwidth in the isochronous transmission period TPI. The bandwidth reservation unit 14 further establishes a stream lookup table SLT, which includes mapping information for each of the M sub-periods TPI_1-TPI_M, according to the mentioned bandwidth registration operation. For example, the stream lookup table SLT includes M data rows for recording mapping information Imap_1, Imap_2, . . . , Imap_n, each of which is for mapping the isochronous streams Ss_1-Ss_n to the corresponding sub-periods TPI_1-TPI_M that the isochronous streams Ss_1-Ss_n are transmitted in, as depicted in FIG. 10.

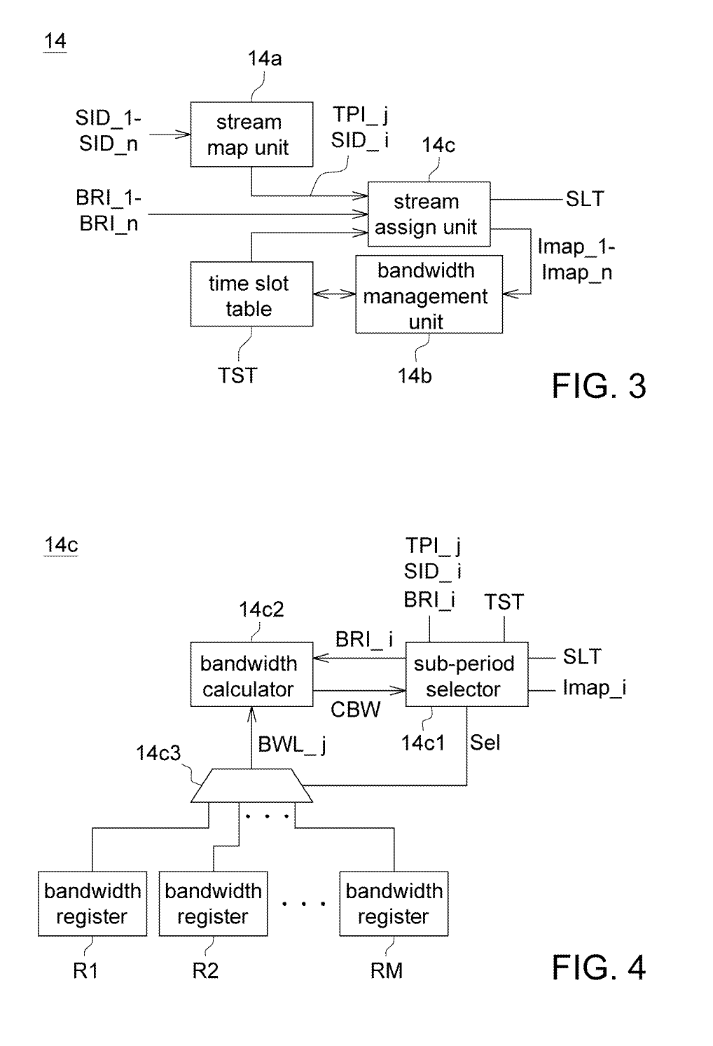

Referring to FIG. 3, a detailed block diagram of the bandwidth reservation unit 14 of FIG. 1 is shown. For example, the bandwidth reservation unit 14 includes a stream map unit 14a, a bandwidth management unit 14b, and a stream assign unit 14c etc. The stream map unit 14a receives the stream identification information SID in the registration information packet and finds a transmission sub-period TPI_j corresponding thereto according to the stream identification information SID. For example, the stream map unit 14a selects a mapping target sub-period in a lowest to highest order. In other words, corresponding to the first isochronous stream entering the bandwidth registration operation, the stream map unit 14a selects the first sub-period TPI_1 as the mapping target sub-period and the stream identification information SID, the transmission sub-period TPI_j and the bandwidth requirement information BRI will be transmitted to the stream assign unit 14c. The stream assign unit 14c arranges the transmission operation of the n isochronous streams Ss_1-Ss_n to the M sub-periods TPI _1-TPI_M and generates the mapping information Imap_{—}1-Imap_n after determining that the corresponding target sub-periods have adequate bandwidths for transmission.

Referring to FIG. 4, the stream assign unit 14c includes a sub-period selector 14c1, a bandwidth calculator 14c2, bandwidth registers R1, R2, . . . , RM, and a multiplexer 14c3 etc. The bandwidth registers R1-RM store M pieces of remained bandwidth information BWL_1, BWL_2, . . . , BWL_M, which are stored in a time slot table TST, of the respective M sub-periods TPI1-TPI_M.

The sub-period selector 14c1 manages the operation of the stream assign unit 14c to accordingly find the mapping information Imap_1-Imap_n. Since the sub-period selector's operation of finding the mapping information Imap_1-Imap_n of the isochronous streams Ss_1-Ss_n are substantially the same, only the operation of finding an i^{th} mapping information Imap_i of an i^{th} isochronous stream Ss_i is disclosed in the following paragraphs for the sake of conciseness, wherein i is a natural number smaller than or equal to n.

The sub-period selector 14c1 receives the bandwidth requirement information BRI_i, the stream identification information SID_i, and the corresponding sub-period TPI_j corresponding to the i^{th} isochronous stream Ss_i and provides the bandwidth requirement information BRI_i to the bandwidth calculator 14c2. The sub-period selector 14c1 provides a selection signal Se1 to the multiplexer 14c3 to find the remained bandwidth information BWL_j corresponding to the mapping target sub-period, e.g. the sub-period TPI_j, wherein j is a natural number smaller than or equal to M.

The bandwidth calculator 14c2 compares the bandwidth requirement information BRI_i and the remained bandwidth information BWL_j of the sub-period TPI_j and accordingly provides a bandwidth comparison signal CBW to the sub-period selector 14c1, so as to indicate whether the mapping target sub-period (sub-period TPI_j) has adequate bandwidth capable for the transmission operation of the isochronous stream Ss_i. When the mapping target sub-period (sub-period TPI_j) has the adequate bandwidth for the transmission operation of the isochronous stream Ss_i, the sub-period selector 14c1 accordingly provides the mapping information Imap_i indicating that the isochronous stream Ss_i is mapped to the mapping target sub-period (sub-period TPI_j). For example, the mapping information Imap_i includes the stream identification information SID_i, the bandwidth requirement information BRI_i, the corresponding sub-period TPI_j, and remained bandwidth information, etc corresponding to the to be registered i^{th} isochronous stream Ss_i.

When the mapping target sub-period (sub-period TPI_j) fails to have adequate bandwidth for the transmission operation of the isochronous stream Ss_i, the sub-period selector 14c1 adjust the selection signal Se1 to select the next mapping target sub-period, e.g. sub-period TPI_j+1, and provide the corresponding remained bandwidth information BWL_j+1 to the bandwidth calculator 14c2 for repeating similar bandwidth comparison, so as to determine whether the next mapping target sub-period (sub-period TPI_j+1) has the adequate bandwidth for the transmission operation of the isochronous stream Ss_i.

Based on the above, the stream assign unit 14c is capable of arranging the transmission operation of the i^{th} isochronous stream Ss_i in one of the M sub-periods TPI_1-TPI_M according to information provided by the stream map unit 14a, and assuring that the isochronous stream Ss_i is allocated with adequate bandwidths for transmission.

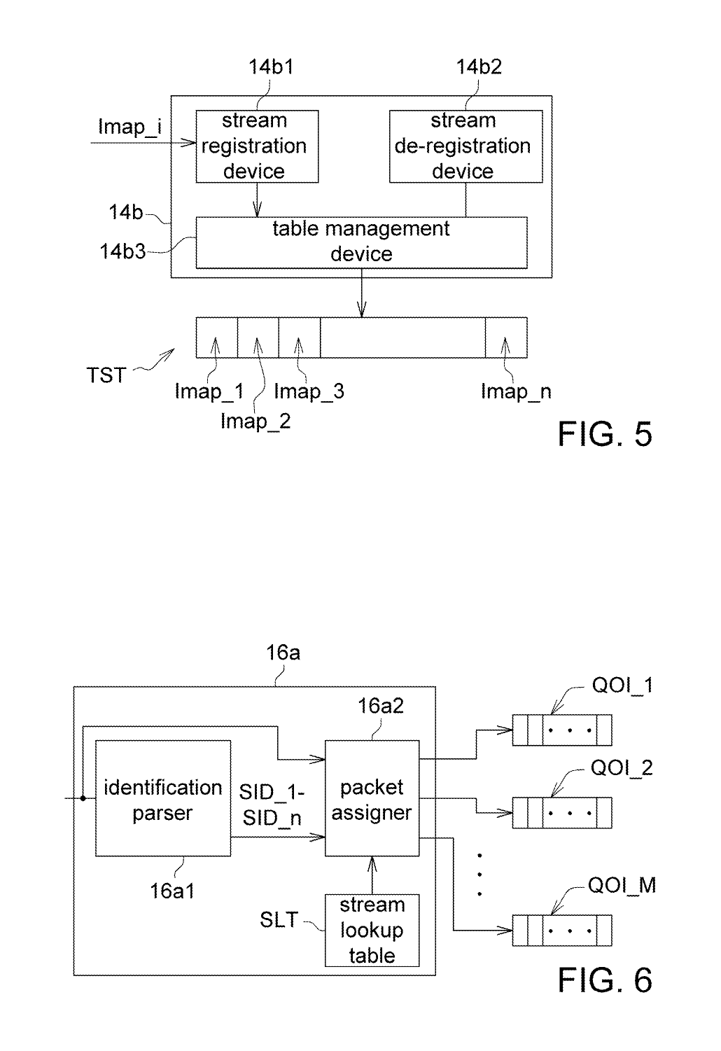

The bandwidth management unit 14b provides a time slot table TST, which indicates the mapping correlation between the i^{th} isochronous stream Ss_i and the sub-periods TPI_1-TPI_M, and the remained bandwidth of the sub-periods TPI_1-TPI_M after the registration operation of the i^{th} isochronous stream Ss_i, in response to the mapping information Imap_i. For example, the bandwidth management unit 14b includes a stream registration device 14b1, a stream de-registration device 14b2, and a table management device 14b3, etc, as depicted in FIG. 5. The table management device 14b3 updates the time slot table TST under the control of the stream registration and stream de-registration devices 14b1 and 14b2.

Thus, the bandwidth reservation unit 14 can achieve the registration operation of the i^{th} isochronous stream Ss_i with the correlated operation carried out by the stream map unit 14a, the stream assign unit 14c and the bandwidth management unit 14b mentioned above. The registration operation for the other isochronous streams Ss_1-Ss_n of bandwidth reservation unit 14 can be obtained according to the above described registration operation of the i^{th} isochronous stream Ss_i and the description thereof is spared for the sake of conciseness.

In an example, the stream assign unit 14c generates according to the time slot table TST when all of the n isochronous streams Ss_1-Ss_n have finished the bandwidth registration operation and accordingly provides the stream lookup table SLT to the output port 16.

The output port 16 includes isochronous output queues QOI_1, QOI_2, . . . , QOI_M, a packet assign unit 16a, and an output unit 16b. The isochronous output queues QOI_1-QOI_M correspond to the respective M sub-periods TPI_1-TPI_M and temporally store the isochronous packets about to be transmitted in the respective M sub-periods TPI_1-TPI_M.

The packet assign unit 16a receives and allocates the isochronous packets to the M isochronous output queues QOI_1-QOI_M according to the stream lookup table SLT. For example, the packet assign unit 16a includes an identification parser 16a1 and a packet assigner 16a2, as depicted in FIG. 6.

The identification parser 16a 1 obtains the stream identification information SID_1-SID_n corresponding to each of the isochronous packets. The packet assigner 16a2, based on the identification information of each of the isochronous packets, has each of the isochronous packets corresponded to one of the M sub-periods TPI_1-TPI_M and provides each of the isochronous packets to the corresponding one of the M isochronous output queues QOI_1-QOI_M, with reference to the stream lookup table SLT.

The output unit 16b transmits the packets stored in the M isochronous output queues QOI_1-QOI_M in the respective M sub-periods TPI _1-TPI_M within the isochronous transmission period TPI, so as to transmit the isochronous streams Ss_1-Ss_n to the output end. For example, the output unit 16b is provided with a timer (not shown) for accounting a frame time TPF, so that corresponding timing information is accordingly provided for the output unit 16b to carry out the corresponding isochronous transmission operation in the isochronous transmission period TPI.

In the present embodiment, the input port 10 further temporally stores asynchronous packets P1, which includes a registration information packet. The switch 12 receives the asynchronous packets P1 and the registration information packet stored in the input queue 10a, and provides the registration information packet to the bandwidth reservation unit 14. The switch 12 further executes switch operation, so as to obtain asynchronous packet PIs with a transmission destination corresponding to the output port 16.

In an embodiment, the output port 16 includes asynchronous output queue QOL, and the packet assign unit 16a receives and provides the asynchronous packets PIs provided by the switch 12 to the asynchronous output queue QOL. The output unit 16b transmits the asynchronous packets PIs stored in the asynchronous output queue QOL in the asynchronous transmission period TPL within the transmission period TPF. In other words, the transmitter 1 is further capable of carrying out asynchronous packet transmission in the asynchronous transmission period TPL.

Though only the situation that the output port 16 includes one asynchronous output queue (i.e. the asynchronous output queue QOL) is cited as an example in the present embodiment, the transmitter according to the present embodiment is not limited thereto. In other example, two or more than two asynchronous output queues may be included in the output port, and the bandwidth management for asynchronous packets can be achieved with registration operation similar to the previously provided isochronous packets registration operation.

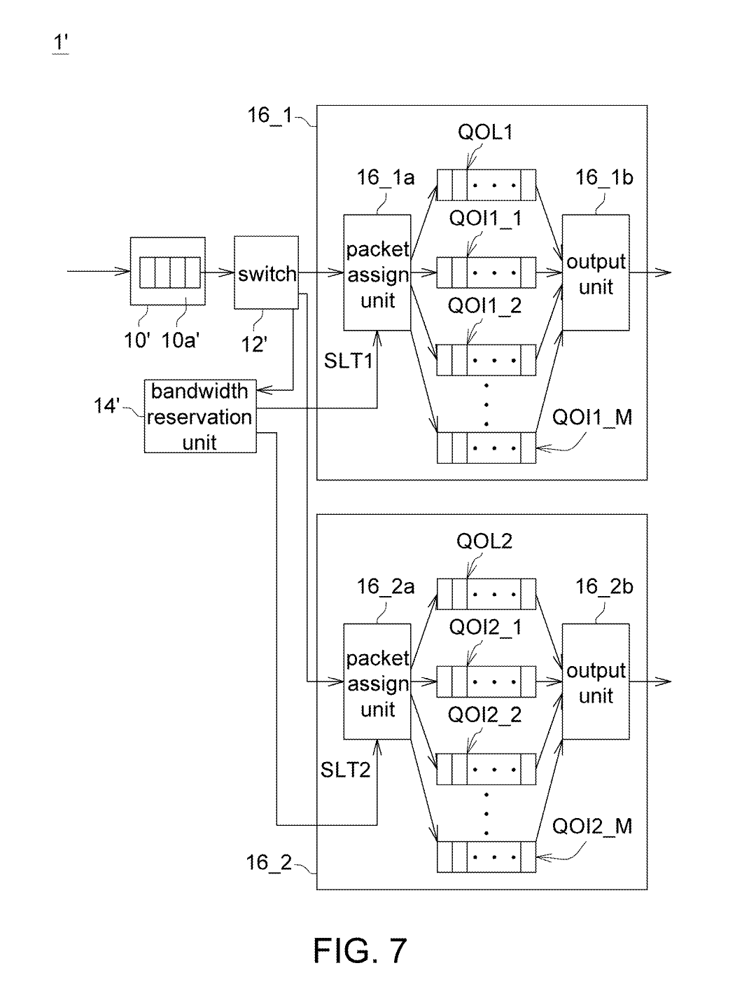

Though only the situation that the transmitter 1 includes one output port (i.e. the output port 16) is cited as an example in the present embodiment, the transmitter 1 according to the present embodiment is not limited thereto. In other example, two or more than two output ports may be included in the transmitter 1. For example, a transmitter 1′ includes two output ports 16_1 and 16_2, as depicted in FIG. 7. In this example, switch 12′ finds packets corresponding to the respective output ports 16_1 and 16_2 according to the destination information included therein. Thus, similar to the transmitter 1 shown in FIG. 1, the transmitter 1′ shown in FIG. 7 can achieve bandwidth reservation operation on the isochronous streams Ss_1-Ss_n corresponding to the output port 16_1 and the isochronous streams Ss_1′-Ss_n′ corresponding to the output port 16_2 by employing the bandwidth reservation unit 14′.

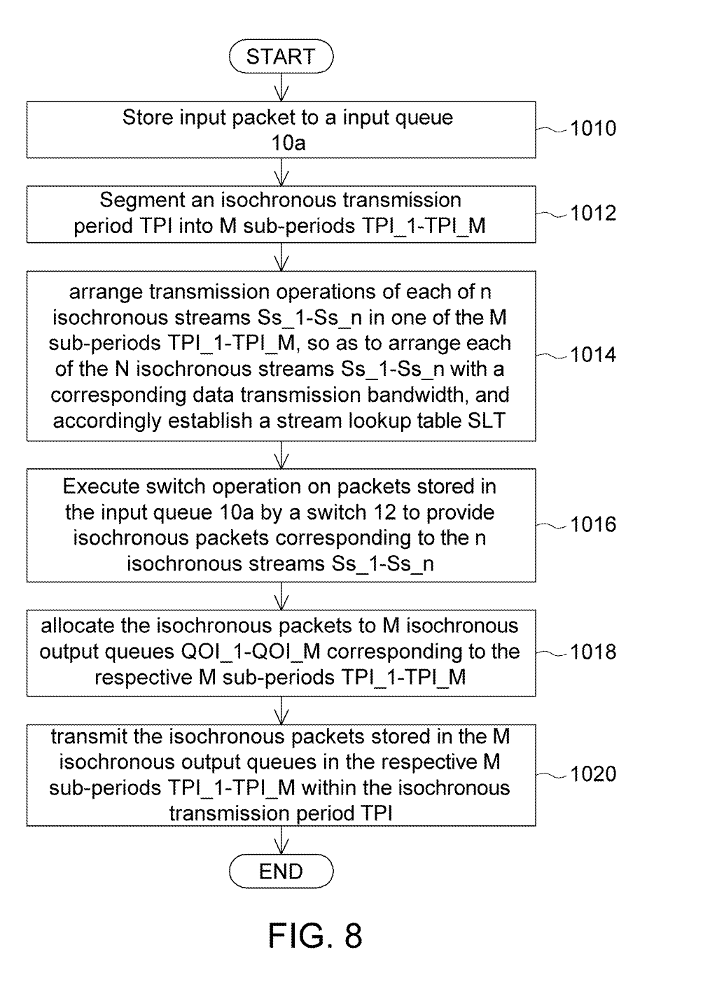

Referring to FIG. 8, a flow chart of a bandwidth arrangement method according to the present embodiment is shown. The bandwidth arrangement method according to the present embodiment includes the following steps. As shown in step (1010), the input packets are stored in the input queue 10a. As shown in step (1012), the bandwidth reservation unit 14 segments the isochronous transmission period TPI into the M sub-periods TPI_1-TPI_M, each of which corresponds to the transmission bandwidth BW, according to according to the registration information packet, wherein M is relevant to the transmission bandwidth and the packet length of the network environment. As shown in step (1014), the bandwidth reservation unit 14 arranges the transmission operation of each of the n isochronous streams Ss_1-Ss_n in one of the sub-periods TPI_1-TPI_M according to the bandwidth requirement information BRI_1-BRI_n of the respective n isochronous streams Ss_1-Ss_n, so as to allocate adequate transmission bandwidth for each of the n isochronous streams Ss_1-Ss_n in the isochronous transmission period TPI. Furthermore, the stream lookup table SLT is also accordingly established.

As shown in step (1016), the switch 12 carries out switch operation on the packets stored in the input queue 10a, so as to output the isochronous packets corresponding to the n isochronous streams Ss_1-Ss_n, wherein the n isochronous streams Ss_1-Ss_n are corresponding to the stream identification information SID_1-SID_n.

As shown in step (1018), the packet assign unit 16a allocates the isochronous packets to the M isochronous output queues QOI_1-QOI_M, which correspond to the respective M sub-periods TPI_1-TPI_M, according to the stream lookup table SLT. As shown in step (1020), the output unit 16b transmits the packets stored in the M isochronous output queues

QOI_1-QOI_M in the respective M sub-periods TPI_1-TPI_M within the isochronous transmission period TPI

The bandwidth arrangement method and the transmitter thereof according to the present embodiment carry out transmission operation of a number of isochronous streams. The bandwidth arrangement method and the transmitter thereof according to the present embodiment arrange a number of sub-periods in an isochronous transmission period of a transmission period based on network environment parameters. The bandwidth arrangement method and the transmitter thereof according to the present embodiment further arranges the transmission operation of each of the isochronous streams in one of the sub-periods according to the bandwidth requirement information of the respective isochronous streams, so as to allocate adequate transmission bandwidth for each of the isochronous streams in the isochronous transmission period. Thus, in comparison to conventional isochronous stream transmission device, the bandwidth arrangement method and the transmitter thereof according the present embodiment is advantageously capable of arranging transmission bandwidths to a number of corresponding isochronous streams and assuring that each of the isochronous streams is allocated with adequate bandwidths for transmission.

In an example, as depicted in FIG. 9, besides the must-have information, e.g. the source and destination address information, the registration information packet further includes critical information, e.g. the stream identification information SID and the bandwidth requirement information BRI.

In an example, FIG. 10 depicts a format of the stream lookup table SLT, which is established by the bandwidth reservation unit 14 according to the registration information packets. The stream lookup table SLT includes information from a number of time slot tables TST.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A transmitter provided in a network environment, the transmitter comprising:
an input port, comprising an input queue for temporally storing a plurality of first isochronous packets corresponding to N first isochronous streams, each of which comprises first stream identification information and first bandwidth requirement information, wherein N is a natural number greater than 1;
a bandwidth reservation unit, having an isochronous transmission period segmented into M sub-periods, each of which corresponds with a first transmission bandwidth, the bandwidth reservation unit further establishing a first stream lookup table and having transmission operations of each of the N first isochronous streams arranged in one of the M sub-periods according to first bandwidth requirement information corresponding to the respective N first isochronous streams, so as to have each of the N first isochronous streams arranged with a corresponding data transmission bandwidth, wherein M is a natural number greater than 1 and is relevant to a transmission bandwidth and a packet length of the network environment; and
a first output port, comprising:
M first isochronous output queues, corresponding to the respective M sub-periods;
a first packet assign unit, receiving and allocating the first isochronous packets to the M first isochronous output queues according to the first stream lookup table; and
a first output unit, transmitting the first isochronous packets stored in the M first isochronous output queues in the respective M sub-periods within the isochronous transmission period.

2. The transmitter according to claim 1, wherein the bandwidth reservation unit comprises:
a stream map unit, receiving the first stream identification information corresponding to each of the first isochronous packets;
a bandwidth management unit, arranging each of the N first isochronous streams to one of the M sub-periods and generating mapping information corresponding to each of the N first isochronous streams, so as to achieve bandwidth registration operations of each of the N first isochronous streams; and
a steam assign unit, providing a time slot table, which indicates the mapping correlation between the N first isochronous streams and the M sub-periods.

3. The transmitter according to claim 2, wherein the stream assign unit further generates and provides the first stream lookup table to the first packet assign unit according to the time slot table, after the bandwidth registration operation of the N first isochronous streams is achieved.

4. The transmitter according to claim 1, wherein the first packet assign unit comprises:
an identification parser, obtaining the first stream identification information corresponding to each of the first isochronous packets; and
a packet assigner, based on the first identification information of each of the first isochronous packets, having each of the first isochronous packets corresponded to one of the M sub-periods and providing each of the first isochronous packets to the corresponding one of the M first isochronous output queues, with reference to the first stream lookup table.

5. The transmitter according to claim 1, wherein the input queue further temporally stores a plurality of asynchronous packets, wherein,
the first output port further includes Q asynchronous output queues, and the first packet assign unit further receives and provides the asynchronous packets to one of the Q asynchronous output queues, wherein Q is a natural number; and
the first output unit further transmits the asynchronous packets stored in the Q asynchronous output queues in an asynchronous transmission period.

6. The transmitter according to claim 1, further comprising:
a switch, carrying out switch operations on the first isochronous packets stored in the input queue according to destination information corresponding to each of the first isochronous streams.

7. The transmitter according to claim 1, wherein the input queue further receives and temporally stores a plurality of second isochronous packets corresponding to N′ second isochronous streams, each of the N′ second isochronous streams corresponds with second stream identification information and second bandwidth requirement information, and N′ is a natural number greater than 1, wherein,
the bandwidth reservation unit further has the isochronous transmission period segmented into M′ sub-periods, each of which corresponds with a second transmission bandwidth;
the bandwidth reservation unit further establishing a second stream lookup table and having transmission operation of each of the N′ second isochronous streams arranged in one of the M′ sub-periods according to second bandwidth requirement information corresponding to the respective N′ second isochronous streams, so as to have each of the N′ second isochronous streams arranged with a corresponding data transmission bandwidth, wherein M′ is a natural number greater than 1 and is relevant to the transmission bandwidth and the packet length of the network environment.

8. The transmitter according to claim 7, further comprising a second output port, wherein the second output port comprises:
M′ second isochronous output queues, respectively corresponding to the respective M′ sub-periods;
a second packet assign unit, receiving and allocating the second isochronous packets to the M′ second isochronous output queues according to the second stream lookup table; and
a second output unit, transmitting the second isochronous packets stored in the M′ second isochronous output queues in the respective M′ sub-periods within the isochronous transmission period.

9. A bandwidth arrangement method applied in a transmitter, the bandwidth arrangement method comprising:
receiving and temporally storing a plurality of isochronous packets corresponding to N isochronous streams in an input queue, each of the N isochronous streams comprising stream identification information and bandwidth requirement information, wherein N is a natural number greater than 1;
having an isochronous transmission period segmented into M sub-periods, each of which corresponds with a transmission bandwidth, wherein M is a natural number greater than 1 and is relevant to a transmission bandwidth and a packet length of the network environment;
having transmission operations of each of the N isochronous streams arranged in one of the M sub-periods according to bandwidth requirement information corresponding to the respective N isochronous streams, so as to have each of the N isochronous streams arranged with a corresponding data transmission bandwidth, and establishing a stream lookup table;
allocating the isochronous packets to M isochronous output queues corresponding to the respective M sub-periods according to the stream lookup table; and
transmitting the isochronous packets stored in the M isochronous output queues in the respective M sub-periods within the isochronous transmission period.

10. The bandwidth arrangement method according to claim 9, wherein the step of having each of the N isochronous streams arranged with the corresponding data transmission bandwidth and establishing the stream lookup table further comprises:
obtaining the first stream identification information corresponding to each of the first isochronous packets;
arranging each of the N first isochronous streams to one of the M sub-periods and generating mapping information corresponding to each of the N first isochronous streams, so as to achieve bandwidth registration operations of each of the N first isochronous streams; and
obtaining a time slot table, which indicates the mapping correlation between the N first isochronous streams and the M sub-periods.

11. The bandwidth arrangement method according to claim 10, wherein the step of having each of the N isochronous streams arranged with the corresponding data transmission bandwidth and establishing the stream lookup table further comprises:
generating and providing the stream lookup table according to the time slot table, after the bandwidth registration operation of the N isochronous streams is achieved.

12. The bandwidth arrangement method according to claim 9, further comprising:
temporally storing a plurality of asynchronous packets in the input queue;
providing the asynchronous packets to an asynchronous output queue; and
transmitting the asynchronous packets stored in the asynchronous output queue in an asynchronous transmission period.

13. The bandwidth arrangement method according to claim 12, further comprising:
carrying out switch operations on the asynchronous packets stored in the input queue.

14. The bandwidth arrangement method according to claim 9, further comprising:
carrying out switch operations on the isochronous packets stored in the input queue.
